(19) United States
(12) Patent Application Publication
(10) Pub. No.: US 2005/0052876 A1
(43) Pub. Date: Mar. 10, 2005

(54) Umbrella mounted chandelier

(76) Inventors: Rex W. Halverson, Folsom, CA (US); Gail A. Halverson, Folsom, CA (US)

Correspondence Address: MICHAEL H JESTER, 505 D GRAND CARIBE CAUSEWAY, CORONADO, CA, 92118, US

(21) Appl. No.: 10/659,865

(22) Filed: Sep. 10, 2003

(51) Int. Cl. F21S 8/06

(52) U.S. Cl. 362/406

(57) ABSTRACT

A chandelier is provided that is suitable for mounting on a patio table umbrella that has a canopy supported by a plurality of ribs that extend radially from the upper end of a vertical post and a plurality radially extending struts connected to the ribs. The chandelier includes a frame configured to surround the post. A plurality of hangers or other attachment mechanisms each connect the frame to a corresponding one of the struts and uniformly suspend the frame below the canopy at a plurality of circumferentially spaced locations at a predetermined safe distance above a horizontal table surface through which the post extends. A plurality of candles, oil lamps or other luminary devices are mounted on the frame for providing decorative illumination.

### FIELD OF THE INVENTION

The present invention relates to luminaries, and more particularly, to outdoor lighting.

### BACKGROUND OF THE INVENTION

Outdoor entertaining is very popular when the weather is pleasant. Many residential back yards and restaurants with outdoor dining have patio tables with umbrellas. The umbrellas typically comprise a round fabric canopy supported by a plurality of ribs that extend radially and downwardly from the upper end of a vertical post. The inner ends of the ribs are typically pivotally connected to the upper end of the post so that the canopy can be collapsed during periods of high wind or when the umbrella is stored. The umbrella typically also has a plurality of radially extending struts whose inner ends are pivotally connected to a collar that slides up and down around the post. The outer ends of the struts are pivotally connected to corresponding ribs outward of the post. The intermediate segment of the post extends through a hole in the center of a round horizontal table surface. The lower end of the post is normally inserted into a cylindrical receptacle in a heavy base situated on the patio floor.

For romantic evening dining it is desirable to have candles or oil lamps that produce a low level of decorative illumination with an appealing glow. However, a typical patio table with an umbrella has a relatively small table surface. It is undesirable to place candles or oil lamps on the table surface itself since space is limited and room needs to be reserved for plates, flatware, serving dishes, glasses, wine bottles, etc. Furthermore, candles and oil lamps with a low profile tend to become hidden on a crowded patio table and their aesthetic effect is therefore compromised. Candles and oil lamps that are tall can be unstable and dangerous, especially when placed on wrought iron or slatted table surfaces that are often used in patio tables.

One luminary that has addressed this problem and which has been commercially available in the United States comprises a metal frame that is clamped around the umbrella post several inches above the surface of the patio table. The frame has diametrically extending branches or arms that support a pair of removable oil lamps. The amount of decorative illumination and the aesthetic appeal of this twin umbrella light is limited. Furthermore, the mounting of this light depends upon having curved clamping portions of the frame that have an inner diameter that matches the outer diameter of the umbrella post. Therefore this twin umbrella light must be manufactured in different configurations in order to fit different sizes of umbrella posts.

### SUMMARY OF THE INVENTION

It is therefore the primary object of the present invention to provide an improved luminary for mounting to a patio table umbrella.

In accordance with our invention a chandelier is provided that is suitable for mounting on a patio table umbrella that has a canopy supported by a plurality of ribs that extend radially from the upper end of a vertical post and a plurality radially extending struts connected to the ribs. The chandelier includes a frame configured to surround the post. A plurality of hangers or other attachment mechanisms each connect the frame to a corresponding one of the struts and uniformly suspend the frame beneath the canopy at a plurality of circumferentially spaced locations at a predetermined safe distance above a horizontal table surface through which the post extends. A plurality of candles, oil lamps or other luminary devices are mounted on the frame for providing decorative illumination.

Our invention also provides a novel method of mounting a chandelier on an umbrella having a canopy supported by a plurality of ribs that extend radially from the upper end of a vertical post and a plurality of radially extending struts connecting the ribs and a collar surrounding the post. The method comprises the initial step of inserting the post through a frame having a plurality of luminary devices such as candles mounted on the frame for providing decorative illumination. The frame is configured to surround the post. Next the post is supported so that it extends vertically. The next step of the method involves connecting the frame to the struts, the ribs or the collar to uniformly suspend the frame beneath the canopy at a plurality of circumferentially spaced locations.

### BRIEF DESCRIPTION OF THE DRAWINGS

FIG. 1 is a diagrammatic vertical sectional view of the preferred embodiment of our chandelier mounted to a conventional patio table umbrella.

FIG. 2 is an enlarged perspective view of the preferred embodiment of our chandelier showing details of its construction.

FIG. 3 is a still further enlarged perspective view of one of the votive candle holders of the preferred embodiment.

### DESCRIPTION OF THE PREFERRED EMBODIMENT

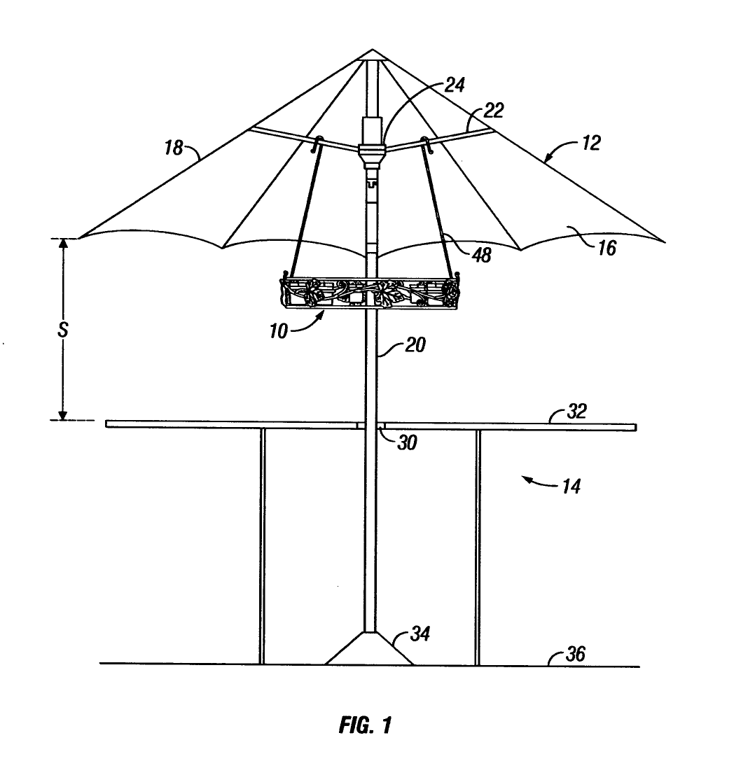

Referring to FIG. 1, in accordance with the preferred embodiment of our invention a chandelier 10 is provided that is suitable for mounting on an umbrella 12 supported in the center of a patio table 14. The umbrella 12 has a fabric canopy 16 that is supported by a plurality of ribs 18 that extend radially from the upper end of a vertical post 20. A plurality radially extending struts 22 are each connected to corresponding ribs 18. The inner ends of the ribs 18 are pivotally connected to the upper end of the vertical post 20 so that the canopy 16 can be collapsed during periods of high wind or when the umbrella 12 is not in use or stored. The inner ends of the struts 22 are pivotally connected to a cylindrical collar 24 that slides up and down around the vertical post 20. The outer ends of the struts 22 are pivotally connected to corresponding ribs 18 outward of the post 20. The canopy 16 is unfolded by raising the collar 24 which may be fixed at a predetermined vertical position along the post 20 with a pin (not illustrated) inserted in a selected one of a plurality of holes (not illustrated) formed in the post 20. The struts 22 then carry the weight or load on the extended ribs 18. Collectively the ribs 18, struts 22, the post 20 and the pinned collar 24 provide a supporting structure for the canopy 16. The umbrella 12 is collapsed by removing the pin and sliding the collar 24 downwardly.

The intermediate segment of the post 20 extends through a hole 30 in the center of a round horizontal table surface 32 of the patio table 14. The lower end of the post 20 is inserted into a cylindrical receptacle (not illustrated) in a heavy base 34 situated on the patio floor 36 under the patio table 14. When the umbrella 12 is opened, people seated at the patio table 14 are shaded from the sun by the extended canopy 16.

The illustrated umbrella 12 is fabricated in the so-called “plantation umbrella” or “market umbrella” style in which the ribs 18, post 20 and struts 22 are made of hard wood such as teak and the canopy 16 is made of a natural woven fabric such as canvas or a similar appearing synthetic fabric.

Many modern patio umbrellas have supporting structures and a post made entirely of metal, such as aluminum and use a canopy made of synthetic material such as plastic web material for increased durability. These modern patio umbrellas have a hand crank on the post that can be turned to open and close the canopy. Our invention can be used with both plantation style patio umbrellas and modern patio umbrellas

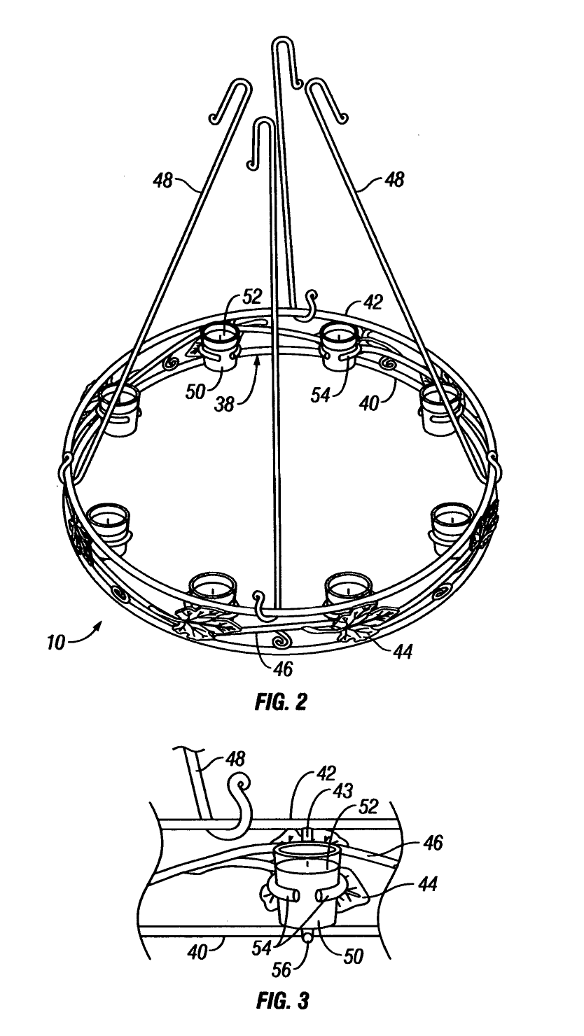

Referring to FIG. 2, the chandelier 10 includes a frame 38 configured to surround the post. More specifically the frame 38 is configured in the form of a pair of vertically spaced cylindrical metal rings 40 and 42 which are connected by eight circumferentially spaced vertical metal posts 43 which are welded or soldered to the rings 40 and 42. Artistic elements in the form of stylized metal grape leaves 44 and grape vines 46 are welded or soldered to the outer sides of the vertical posts 43. A plurality of double ended metal hooks 48 are used to connect the frame 38 to a corresponding one of the struts 22 and uniformly suspend the frame 38 beneath the canopy 16 at a plurality of circumferentially spaced locations at a predetermined safe distance S (FIG. 1) above the horizontal table surface 32 through which the vertical post 20 extends. The upper curved ends of the hooks 48 preferably surround the corresponding struts. Alternatively, holes may be drilled horizontally through the wooden struts 22 at the appropriate locations and the upper ends of the hooks 48 can be less curved so that they can be inserted through the same.

A plurality of cylindrical glass holders 50 (FIG. 2) are mounted at spaced circumferential locations around the frame 38 and each removably receive a corresponding one of a plurality of votive candles 52 that when lighted provide the desired decorative illumination. Referring to FIG. 3, the glass holders 50 are preferably mounted to the frame 38 in a mounting structure such as split metal rings 54 which are openable and/or adjustable in size by bending to accept and hold different sizes of holders 50. Each of the split metal rings 54 is welded or soldered to the inside surface of a corresponding one of the vertical metal posts 43. A horizontal metal extension 56 is also welded or soldered to the inside of the lower ring 40 at the same point where the lower end of the corresponding post 43 is attached. The horizontal metal extension 56 supports the underside of the glass holder 50.

The distance S (FIG. 1) is selected by making the double ended hooks 48 the correct length so that the frame 38 of the chandelier 10 is well above eye level of an adult seated at the patio table 14. The chandelier 10 should be suspended low enough so that the flame from any of the candles 52 will not ignite the fabric canopy 16. The diameter of the rings 40 and 42 that make up the major portion of the frame 38 is preferably less than the diameter of the horizontal table surface 32 of the patio table 14 to ensure that a person does not bump the same with his or her head when they stand up. The diameter of the rings 40 and 42 is also preferably large enough to easily support eight (8) votive candles yet small enough to achieve the desired aesthetic effect. By way of example only, the length of the double ended hooks 48 may be twenty-four inches, and the diameter of the rings 40 and 42 may be twenty-six inches where the horizontal table surface 32 of the patio table 14 measures approximately forty-three inches in diameter.

Satisfactory stability is achieved by using four equally circumferentially spaced hooks 48 to suspend the frame 38 from four of the struts 22 of the umbrella 12. The candles 52 and the hooks 48 are interspersed around the frame 38. In other words, in the preferred embodiment of our chandelier 10 the four hooks 48 are connected at ninety degree intervals around the circular frame 38 and the eight candles 52 are supported in corresponding holders 50 mounted at forty-five degree intervals around the circular frame 38 at locations staggered from those of the hooks 48. Each of the four hooks 48 are attached to the upper ring 42 slightly offset from an adjacent holder 50. This ensures that none of the candles 52 is situated beneath any of the struts 22 which are made of wood and could be singed or set on fire by a candle flame situated too close to the same.

It will also be appreciated that we have provided a novel method of mounting a chandelier 10 on a patio table umbrella 12 having a canopy 16 supported by a plurality of ribs 18 that extend radially from the upper end of a vertical post 20 and a plurality of radially extending struts 22 connecting the ribs 18 and a collar 24 surrounding the post 20. The method comprises the initial step of inserting the post 20 through a frame 38 having a plurality of means such as candles 52 mounted on the frame for providing decorative illumination. The frame 38 is configured to surround the post 20 which is then slid through the opening in the center of the horizontal table surface 32 of a patio table 14 and into a base 34. Optionally the lower end of the post 20 may be directly inserted into the base 34 where the umbrella 12 is not used with a table. The next step of the method involves connecting the frame 38 to a plurality of the struts 22 to uniformly suspend the frame 38 beneath the canopy 16 at a plurality of circumferentially spaced locations.

While we have described a preferred embodiment of our umbrella mounted chandelier 10 in detail, variations and modifications thereof will readily occur to those skilled in the art. For example, other means for providing decorative illumination could be used in place of the candles 52 including oil lamps and low voltage incandescent lamps powered by a battery pack inconspicuously mounted on the frame 38. Fragrant candles or citronella candles could be used. Citronella oil or liquid paraffin oil could be used in the oil lamps. Miniature liquid propane torches could also be used. Other connecting means could be used in place of the double ended hooks 48 such as cords, wires, rods, links, decorative rigid elongate members and so forth. The frame 38 could be suspended from the ribs 18, the canopy 16 and/or the collar 24 by connecting suitable attachment mechanisms extending from the frame 38 directly or indirectly to these structures. The attachment mechanisms could be integral parts of the frame itself in stead of separate hooks 48. The frame 38 could have a wide variety of artistic configurations including metal discs and rectangles connecting the rings 40 and 42 instead of the grape leaves 44 and grape vines 46. The frame 38 need not be ring-shaped but could have a more traditional configuration associated with chandeliers suspended from the ceiling. In this configuration the inner ends of radial branches would be connected to a collar that surrounds the vertical post 20 and the outer ends of the branches would be connected to the struts 22 by the double ended hooks 48. Our chandelier 10 can be mounted on the umbrella 12 with our without the patio table 14. Where the patio table 14 is utilized, it may support the post 20 vertically without the need for the base 34 and may instead have a lower crisscross or other horizontally extending frame work through which a lower end of the post 20 extends. Therefore, the protection afforded our invention should only be limited in accordance with the scope of the following claims.

1. A chandelier suitable for mounting on a patio table umbrella having a canopy supported by a plurality of ribs that extend radially from the upper end of a vertical post and a plurality of radially extending struts connected to the ribs, the chandelier comprising:
a frame configured to surround the post;
a plurality of means for each connecting the frame to a corresponding one of the struts and uniformly suspending the frame beneath the canopy at a plurality of circumferentially spaced locations at a predetermined safe distance above a horizontal table surface through which the post extends; and
a plurality of means mounted on the frame for providing decorative illumination.

2. The chandelier of claim 1 wherein the frame is configured in the form of a ring.

3. The chandelier of claim 1 wherein the connecting means each comprise a hanger.

4. The chandelier of claim 1 and further comprising a plurality of holders connected to the frame for each removably receiving a corresponding one of the decorative illumination means.

5. The chandelier of claim 1 wherein the decorative illumination means is a candle.

6. The chandelier of claim 1 wherein the decorative illumination means is an oil lamp.

7. The chandelier of claim 1 wherein the decorative illumination means is an incandescent lamp.

8. The chandelier of claim 1 wherein the decorative illumination means and the connecting means are interspersed around the frame.

9. The chandelier of claim 1 wherein the frame is configured in the form of at least one cylindrical metal ring with attached artistic elements.

10. The chandelier of claim 1 wherein the connecting means each comprise double ended hooks.

11. A combination collapsible umbrella, chandelier, and patio table, comprising:
a patio table having a horizontal table surface and a hole in the center of the surface;
an umbrella having a canopy supported by a plurality of ribs that extend radially from the upper end of a post and a plurality of radially extending struts connected to the ribs, the post extending vertically through the hole in the center of the horizontal table surface;
a frame surrounding the post;
a plurality of attachment mechanisms each connecting the frame to a corresponding one of the struts and uniformly suspending the frame beneath the canopy at a plurality of circumferentially spaced locations at a predetermined safe distance above the horizontal table surface through which the post extends; and
a plurality of luminary devices mounted on the frame capable of providing decorative illumination.

12. The combination of claim 11 wherein the frame is configured in the form of a ring.

13. The combination of claim 11 and further comprising a plurality of holders connected to the frame for each removably receiving a corresponding one of the luminary devices.

14. The combination of claim 11 wherein the luminary devices are candles.

15. The combination of claim 11 wherein the luminary devices are oil lamps.

16. The combination of claim 11 wherein the luminary devices are incandescent lamps.

17. The combination of claim 11 wherein the luminary devices and the attachment mechanisms are interspersed around the frame.

18. The combination of claim 11 wherein the frame is configured in the form of at least one cylindrical metal ring with attached artistic elements.

19. The combination of claim 11 wherein the attachment mechanisms each comprise double ended hooks.

20. A method of mounting a chandelier on an umbrella having a canopy supported by a plurality of ribs that extend radially from the upper end of a post and a plurality of radially extending struts connecting the ribs and a collar surrounding the post, the method comprising the steps of:
inserting the post through a frame having a plurality of means mounted on the frame for providing decorative illumination, the frame being configured to surround the post;
supporting the post so that it extends vertically; and
connecting the frame to a supporting structure selected from the group consisting of the struts, the ribs and the collar to uniformly suspend the frame at a plurality of circumferentially spaced locations.
